(19) United States
(12) Patent Application Publication
(10) Pub. No.: US 2013/0167068 A1
(43) Pub. Date: Jun. 27, 2013

(54) METHOD AND APPARATUS FOR PROVIDING A DYNAMIC DISPLAY DIVISION IN A MOBILE TERMINAL

(71) Applicant: Samsung Electronics Co., Ltd., Gyeonggi-do (KR)

(72) Inventor: Simon SIM, Gyeonggi-do (KR)

(73) Assignee: SAMSUNG ELECTRONICS CO., LTD., Gyeonggi-do (KR)

(21) Appl. No.: 13/723,998

(22) Filed: Dec. 21, 2012

(30) Foreign Application Priority Data
Dec. 22, 2011 (KR) 10-2011-0140295

(51) Int. Cl. G06F 3/0481

(52) U.S. Cl. CPC G06F 3/0481
USPC 715/781

(57) ABSTRACT

A method for providing a dynamic screen division in a mobile terminal screen is provided where a division boundary line of an arbitrary shape for screen division defined by a user is detected, and at least one application program to be displayed in respective layer is selected so that one or more application programs are allocated to the respective layers are merged using the division boundary line defined by the user as a reference for a simultaneous display.

### CLAIM OF PRIORITY

This application claims the benefit under 35 U.S.C. §119(a) of a Korean patent application filed in the Korean Intellectual Property Office on Dec. 22, 2011 and assigned Serial No. 10-2011-0140295, the entire disclosure of which is hereby incorporated by reference.

### BACKGROUND OF THE INVENTION

1. Field of the Invention

The present invention relates to a method and an apparatus for dividing a display screen in a mobile terminal.

2. Description of the Related Art

In the case where a user simultaneously displays a plurality of application programs on a mobile terminal display, the display screen is divided vertically or horizontally by a user interface so that the application program is displayed on the respective vertically or horizontally divided region.

In the case where each application program is executed via the vertically or horizontally divided display screen, an important portion of the relevant program may not be displayed depending on the shape or size of the adjacent divided screen. In this case, a user may feel inconvenience, and thus there is a need to develop an improved user interface that would eliminate this inconvenience.

### SUMMARY OF THE INVENTION

An aspect of the present invention is to address at least the above-mentioned problems and/or disadvantages and to provide at least the advantages described below, by providing a method and an apparatus for enabling a dynamic display division on a mobile terminal display.

Another aspect of the present invention is to provide a method and an apparatus for allowing a user to arbitrarily divide a display screen of a mobile terminal for displaying a plurality of application programs.

Still another aspect of the present invention is to provide a method and an apparatus for allowing a user to arbitrarily divide a region on which an executed application program is displayed when executing a plurality of application programs in a mobile terminal.

In accordance with an aspect of the present invention, a method for dynamic screen division in a mobile terminal includes receiving a division boundary line of an arbitrary shape for screen division, allowing a user to select at least one application program to be displayed together, allocating one or more application programs to independent layers, respectively, merging respective layers using the division boundary line as a reference for a display together, and outputting a merged layer.

In accordance with another aspect of the present invention, an apparatus of a mobile terminal performing dynamic screen division includes an input unit for receiving a division boundary line of an arbitrary shape for screen division and at least one application program to be displayed together, a controller for allocating one or more application programs to independent layers, respectively, and merging respective allocated layers using the division boundary line as a reference for a display together, and an output unit for outputting a merged layer.

In accordance with still another aspect of the present invention, a mobile communication system for performing dynamic screen division includes a network server for receiving and storing a set value of a division boundary line, and a mobile terminal for allowing a user to select a division boundary line of an arbitrary shape for screen division and to select at least one application program to be displayed together, allocating one or more application programs to independent layers, respectively, merging respective allocated layers using the division boundary line as a reference for a display together, outputting a merged layer, and transmitting the set value of the division boundary line to the network server.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a view illustrating an example of dynamic division of an application program according to an exemplary embodiment of the present invention;

FIG. 2 is a view illustrating allocation relation between an application program and a layer according to an exemplary embodiment of the present invention;

FIG. 3 is a view illustrating a division boundary line setting process according to an exemplary embodiment of the present invention;

FIG. 4 is a flowchart illustrating a division boundary line setting process according to an exemplary embodiment of the present invention;

FIG. 5 is a view illustrating a division boundary line loading process according to an exemplary embodiment of the present invention;

FIG. 6 is a flowchart illustrating a division boundary line loading process according to an exemplary embodiment of the present invention;

FIG. 7 is a block diagram illustrating a mobile terminal according to an exemplary embodiment of the present invention; and

FIG. 8 is a block diagram illustrating a network server according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

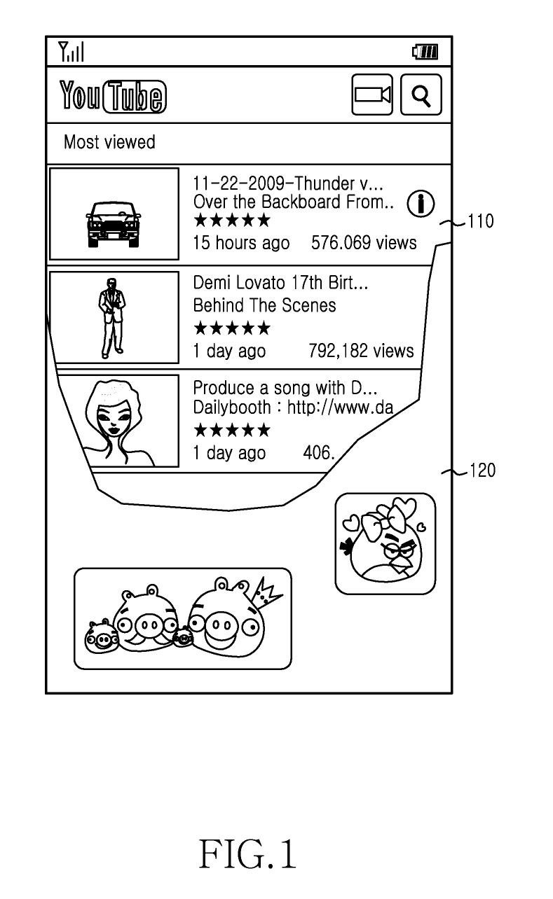

FIG. 1 is a view illustrating an example of dynamic division of an application program according to an exemplary embodiment of the present invention.

Referring to FIG. 1, according to the teachings of the present invention at least two different application programs are displayed in respective display area. A boundary line between an application program 110 and an application program 120 denotes a division boundary line between the two application programs 110 and 120. The division boundary line may be arbitrarily set by a user.

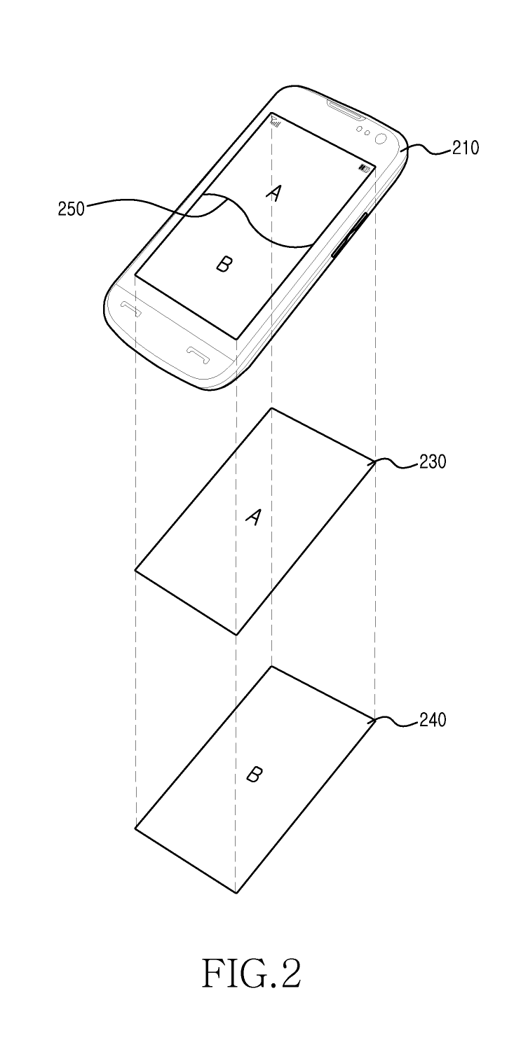

The application programs 110 and 120 are independent layers, respectively. A mobile terminal merges the respective independent layers, and displays the application programs 110 and 120 according to the division boundary line. A detailed explanation of the embodiment shown in FIG. 1 will be explained hereinafter with reference to FIGS. 2-6.

FIG. 2 is a view illustrating allocation relation between an application program and a layer according to an exemplary embodiment of the present invention.

Referring to FIG. 2, an application program A 230 and an application program B 240 are allocated to independent layers, respectively. The layer 230 and 240 represent logical layers in which application programs are running respectively.

In case of displaying the application program A 230 and the application program B 240 together, a mobile terminal displays the application program A 230 and the application program B 240 on a display screen 210 whose displayed region is defined by a preset division boundary line 250. In the embodiment, the shape of a boundary is selectively set according to a user's preference.

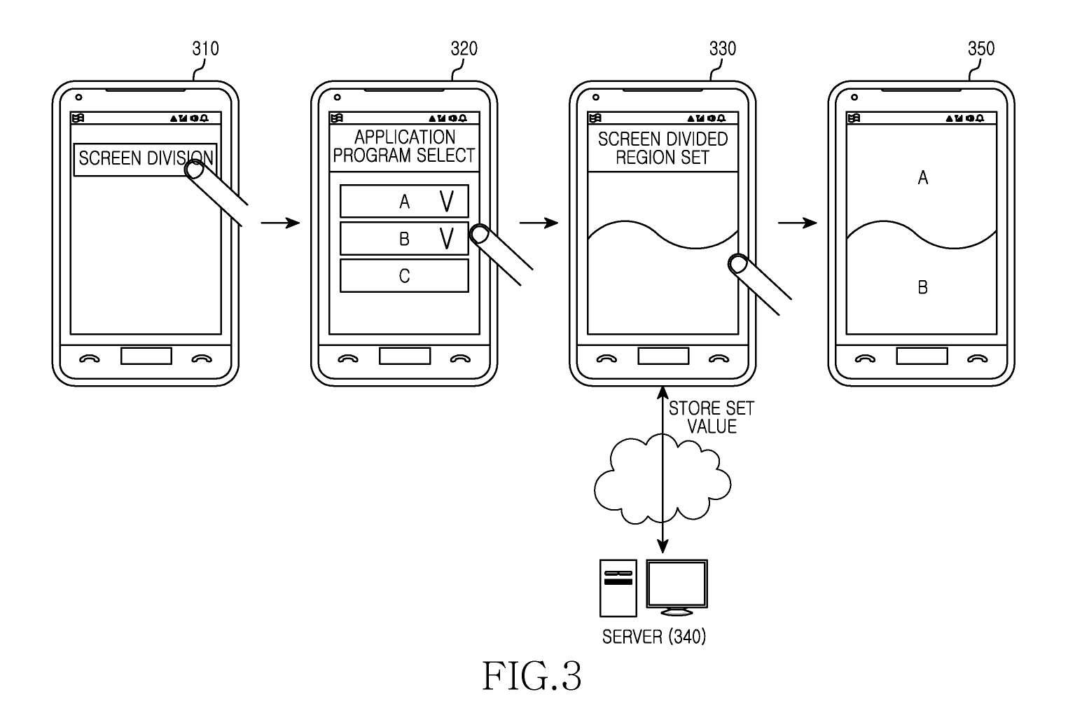

FIG. 3 is a view illustrating a division boundary line setting process according to an exemplary embodiment of the present invention.

Referring to FIG. 3, in operation, a user selects a screen divide function of a mobile terminal (step 310), and then selects an application program to be driven during screen division (step 320). For illustrative purposes, the present invention is described using a case where an application program A and an application program B have been selected, as indicated by V. The application program A and the application program B are allocated to independent layers, respectively.

The user performs a screen divide region setting process (step 330). According to an exemplary embodiment of the present invention, the user draws a desired boundary line, i.e., a curve-shaped division boundary line, on a screen, and the mobile terminal merges application programs to display using the division boundary line as a reference, and displays the same (step 350). It should be noted that the user may draw not only the curve-shaped division boundary line but also a division boundary line of any shape desired by the user.

According to an exemplary embodiment of the present invention, the mobile terminal merges and displays respective layers displaying respective running application in both ends of the divided screen region defined by the user as described above. For example, the application program A is displayed on the upper portion above the division boundary line, and the application program B is displayed on the lower portion below the division boundary line.

However, the position of the application program with respect to the divided display screen may change depending on the user's selection. That is, in step 320, the user may designate the desired position of an application program on the divided display screen so that the selected program can be displayed at the desired location. For example, after the selection of desired programs A and B and defining the boundary line, the user may be further prompted to indicate whether to display a particular program in either the upper or lower region.

After the boundary line is defined by the user, the mobile terminal recognizes the boundary line drawn on the screen and stores the value defining the division boundary line (hereinafter, a divided screen region set value). The mobile terminal may store a divided screen region set value in a server 340. This store value may be selected later during operation of the terminal to display multiple layers. Alternatively, the mobile terminal may assign a predetermined set value corresponding to the stored value for later execution.

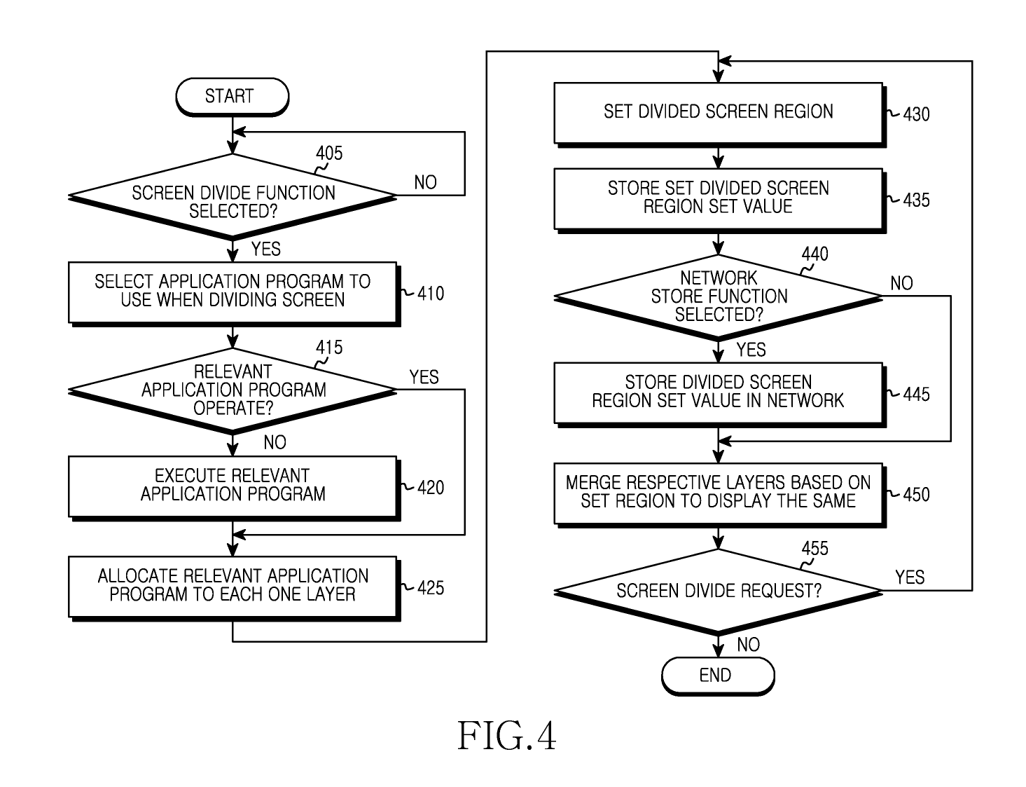

FIG. 4 is a flowchart illustrating a division boundary line setting process according to an exemplary embodiment of the present invention.

Referring to FIG. 4, a user selects a screen divide function in a mobile terminal (step 405). After that, the user selects an application program to use during screen division (step 410).

In the case where a relevant application program, that is, an application program which the user selects for a dual display is not operating currently (step 415), the relevant application program is executed (step 420). Thereafter, the mobile terminal allocates application programs selected by the user to layers, respectively (step 425).

Then, the user sets a screen region to divide to the mobile terminal (step 430), and the mobile terminal stores the set divided screen region set value (step 435). That is, the user selectively draws a division boundary line on the divided region setting screen, and the mobile terminal recognizes the boundary line drawn on the screen and stores the value defining the division boundary line.

Here, if a divided screen region set value is selected (step 440), the mobile terminal stores the divided screen region set value in a network, that is, a server on the network (step 445). Thereafter, the mobile terminal may execute the store function based on the divided screen region set value The mobile terminal merges and displays respective layers according to the divided boundary line based on a set region defined in earlier steps (step 450). Meanwhile, when receiving a screen divide request from the user (step 455), the mobile terminal restarts the divided screen region setting step (step 430).

The method described above in relation with FIG. 4 under of the present invention may be provided as one or more instructions in one or more software modules stored in the respective apparatus.

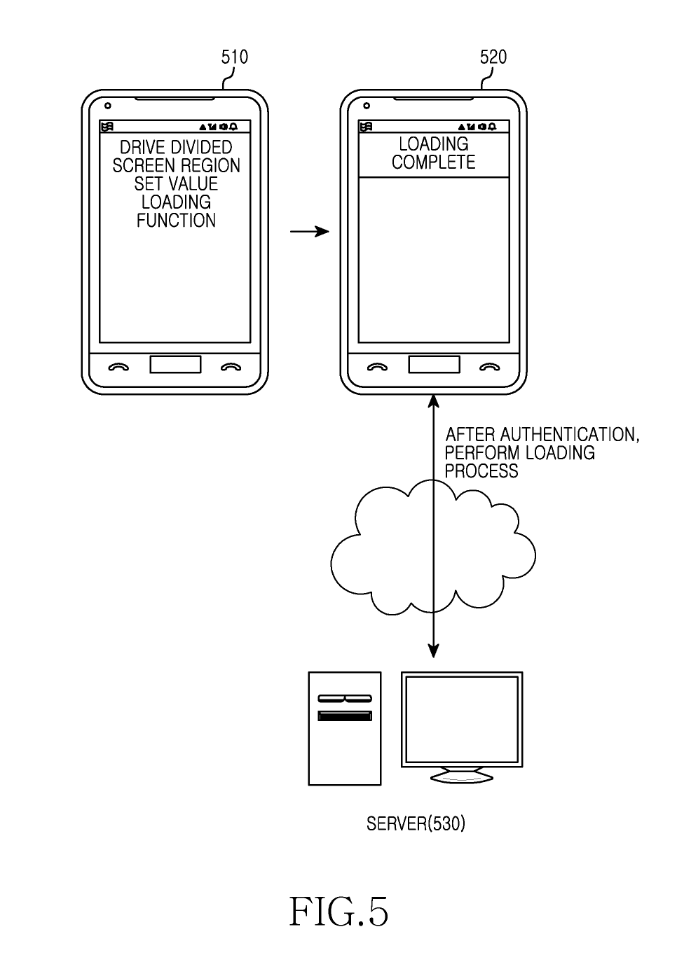

FIG. 5 is a view illustrating a division boundary line loading process according to an exemplary embodiment of the present invention.

Referring to FIG. 5, when a divided screen region set value of the mobile terminal is driven (step 510), the mobile terminal performs authentication of a user, and when the authentication succeeds (step 530), the mobile terminal completes the loading process (step 520).

Note that the divided screen region set value can be stored in the mobile terminal or stored in a network. Further, the authentication process may be also used for a case of storing the divided screen region set value of FIG. 3.

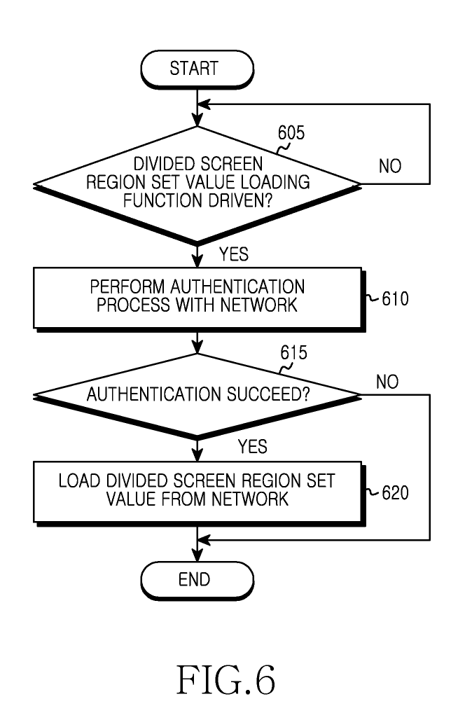

FIG. 6 is a flowchart illustrating a division boundary line loading process according to an exemplary embodiment of the present invention.

Referring to FIG. 6, when a divided screen region set value of the mobile terminal is driven (step 605), the mobile terminal performs authentication for a user with a network (step 610).

After that, when the authentication succeeds (step 615), the mobile terminal loads the divided screen region set value (step 620). That is the mobile terminal downloads the divided screen region set value from the network and the mobile terminal uses the divided screen region set value to display at least one application on a screen region and at least one application on another screen region.

The method described above in relation with FIG. 6 under of the present invention may be provided as one or more instructions in one or more software modules stored in the respective apparatus.

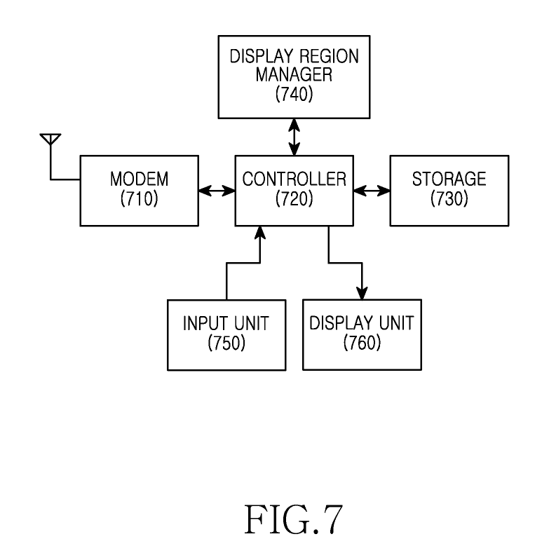

FIG. 7 is a block diagram illustrating a mobile terminal according to an exemplary embodiment of the present invention.

Referring to FIG. 7, the mobile terminal includes a modem 710, a controller 720, a storage 730, a display region manager 740, an input unit 750, and a display unit 760.

The modem 710 serves as a module for communicating with other devices, and includes a Radio Frequency (RF) processor and a baseband processor. The RF processor converts a signal received via an antenna into a baseband signal to provide the same to the baseband processor, and converts a baseband signal from the baseband processor to an RF signal so that it can be actually transmitted on air to transmit the same via the antenna.

The controller 720 controls an overall operation of the mobile terminal, and more particularly, includes or controls the display region manager 740 according to the present invention.

The storage 730 stores a program for controlling an overall operation of the mobile terminal and temporary data generated during execution of a program. Particularly, according to the present invention, the storage 730 stores layer information and a divided screen region set value allocated for an application program.

The input unit 750 provides a user's touch input to the controller 720, and the display unit 760 displays an output of the controller 720.

According to the present invention, the input unit 750 receives a division boundary line input by a user to provide the same to the controller 720, and the display unit 750 outputs a screen corresponding to a merged layer provided by the controller 720.

In the case where a user selects a screen divide function and selects an application program to use during the screen division mode, when the application program to use during screen division is not being operated, the display region manager 740 executes the relevant application program.

In addition, the display region manager 740 allocates application programs selected by the user to layers, respectively.

The user sets a screen region to divide via the input unit 750, and the display region manager 740 stores a set divided screen region set value in the storage 730. This process denotes a process where a user draws a division boundary line on a divided region setting screen, and the display region manager 740 recognizes and stores a divided screen region set value set along the division boundary line.

In the case where the set divided screen region is selected, the display region manager 740 stores the set divided screen region set value in a network. The set divided screen region value may be subsequently selected by the user, and the display region manager 740 may execute the display of programs accordingly. In this case, when needed, an authentication process may be performed.

The display region manager 740 merges respective layers defined by the preset division boundary line to display the same on the display unit 760. The display region manager 740 displays the at least one application which are running according to the division boundary line together. That is, the display region manager 740 merges the respective layers and displayed together along the division boundary line predefined by the user.

When receiving a screen division change request from a user, the display region manager 740 performs the divided screen region setting in step 430 of FIG. 4.

When a divided screen region set value load function is driven, the display region manager 740 of the mobile terminal performs a divided screen region set value. The display region manager 740 may perform an authentication process when performing the loading process.

The mobile terminal may be an electronic device such as, for example, a laptop, a smart phone, a net book, a mobile internet device, an ultra mobile PC, a tablet personal computer, a mobile telecommunication terminal, PDA having a camera and the like herein, just to name some of the possibilities.

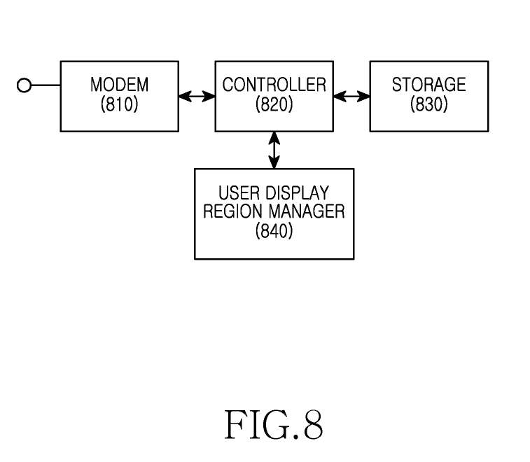

FIG. 8 is a block diagram illustrating a network server according to an exemplary embodiment of the present invention.

Referring to FIG. 8, the network server includes a modem 810, a controller 820, a storage 830, and a user display region manager 840.

The modem 810 serves as a module for communicating with other devices, and includes a wired processor and a baseband processor. The wired processor converts a signal received via a wired path into a baseband signal to provide the same to the baseband processor, and converts a baseband signal from the baseband processor into a wired signal so that it can be transmitted on an actual wired path to transmit the same via the wired path.

The controller 820 controls an overall operation of the network server, and particularly, includes or controls the user display region manager 840 according to the present invention.

The storage 830 stores a program for controlling an overall operation of the network server and temporary data generated during execution of a program. Particularly, according to the present invention, the storage 830 stores layer information and a divided screen region set value allocated for an application program for a user transmitted by a mobile terminal.

The user display region manager 840 stores the divided screen region set value transmitted by the mobile terminal, and transmits the relevant set value to the mobile terminal when the mobile terminal requests the divided screen region set value.

During this process, the user display region manager 840 performs an authentication process on the mobile terminal, and accepts a request of the mobile terminal only if the authentication succeeds to store the divided screen region set value transmitted by the mobile terminal, or transmit the relevant set value to the mobile terminal when the mobile terminal requests the divided screen region set value.

The present invention has an advantage of preventing a user's inconvenience that may occur when a display screen displaying an application program is fixed which prevents from multiple programs from being displayed.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for providing a dynamic screen division in a mobile terminal having a touch screen having a plurality of layers, the method comprising:
detecting a division boundary line on the touch screen;
detecting a selection of at least one application program to be displayed in each divided region;
assigning one or more application programs to respective layer; and
merging respective layers using the division boundary line as a reference for a simultaneous display.

2. The method of claim 1, further comprising transmitting a set value corresponding to the division boundary line to a network.

3. The method of claim 2, further comprising, when transmitting the set value of the division boundary line to the network, performing an authentication process.

4. The method of claim 1, further comprising:
retrieving a set value of the division boundary line from a network.

5. The method of claim 4, further comprising, when retrieving the set value of the division boundary line from the network, performing an authentication process.

6. The method of claim 1, further comprising, when the one or more application programs are not open, executing an application program not executed.

7. An apparatus for performing a dynamic screen division in a mobile terminal having a plurality of layers, comprising:
a touch screen for detecting a division boundary line on a touch screen and a selection of at least one application program to be displayed simultaneously; and
a controller for allocating one or more application programs to the respective layers and merging respective layers using the division boundary line as a reference for a simultaneous display on the touch screen.

8. The apparatus of claim 7, wherein the controller transmits a set value corresponding to the division boundary line to a network.

9. The apparatus of claim 8, wherein when transmitting the set value of the division boundary line to the network, the controller performs an authentication process.

10. The apparatus of claim 7, wherein the controller loads a set value corresponding to the division boundary line from a network.

11. The apparatus of claim 10, wherein when loading the set value of the division boundary line from the network, the controller performs an authentication process.

12. The apparatus of claim 7, wherein when the one or more application programs are not open, the controller executes an application program not executed.

13. A mobile communication system for providing a dynamic screen division, comprising:
a network server; and
a mobile terminal having a plurality of layers for detecting a division boundary line on a screen thereon and a selection of at least one application program to be displayed, allocating one or more application programs to the respective layers, and merging the respective layers using the division boundary line as a reference for a simultaneous display.

14. The system of claim 13, wherein the mobile terminal further transmits a set value corresponding to the division boundary line to the network server.

15. The system of claim 14, wherein when transmitting the set value of the division boundary line to the network, the mobile terminal performs an authentication process.

16. The system of claim 14, wherein the mobile terminal retrieves the set value of the division boundary line from a network.

17. The system of claim 16, wherein when retrieving the set value of the division boundary line from the network, the mobile terminal performs an authentication process.

18. The system of claim 13, wherein when the one or more application programs are not executed, the mobile terminal executes an application program not executed.
